(19) United States
(12) Patent Application Publication
(10) Pub. No.: US 2017/0115062 A1
(43) Pub. Date: Apr. 27, 2017

(54) APPARATUS FOR PRODUCING CEMENT CLINKER

(71) Applicant: SCHEUCH GMBH, Aurolzmuenster (AT)

(72) Inventor: Manfred LISBERGER, Riedau (AT)

(21) Appl. No.: 15/312,163

(22) PCT Filed: May 27, 2015
(86) PCT No.: PCT/AT2015/050136

§ 371 Date: Nov. 17, 2016

(30) Foreign Application Priority Data
May 27, 2014 (AT) GM 50082/2014

(51) Int. Cl. F27B 7/20; C04B 7/47; C04B 7/36; F27B 7/38

(52) U.S. Cl. CPC F27B 7/2016; F27B 7/20; F27B 7/38; C04B 7/47; C04B 7/364

(57) ABSTRACT

An apparatus for producing cement clinker, comprising a kiln for calcining raw materials to form cement clinker, comprising a preheating stage for preheating the raw materials in a counter-flow to kiln off-gases, comprising a clinker cooler for cooling the cement clinker, comprising a denoxing stage for denoxing kiln off-gases, comprising a heat exchanger for heating the kiln off-gases upstream of the denoxing stage by heat exchange with a heat exchange medium, comprising at least one further heat exchanger for heating the heat exchange medium by heat exchange with kiln off-gases or exhaust air of the clinker cooler, wherein the heat exchanger is connected to the further heat exchanger via a line for the heat exchange medium, wherein a hot gas filter is arranged in the flow direction upstream of the further heat exchanger.

The invention relates to an apparatus for producing cement clinker, comprising a kiln for calcining raw materials to form cement clinker, comprising a preheating stage for preheating the raw materials in a counter-flow to kiln off-gases, comprising a clinker cooler for cooling the cement clinker, comprising a denoxing stage for denoxing kiln off-gases, comprising a heat exchanger for heating the kiln off-gases upstream of the denoxing stage by heat exchange with a heat exchange medium, comprising at least one further heat exchanger for heating the heat exchange medium by heat exchange with kiln off-gases or exhaust air of the clinker cooler, wherein the heat exchanger is connected to the further heat exchanger by way of a line for the heat exchange medium.

Such an apparatus for the production of cement clinker is known from EP 2 545 337 B1, wherein the (optionally cooled) flue gas downstream of a preheater is dedusted in a flue gas filter and then fed to a so-called SCR (“selective catalytic reduction”) plant for catalytic denoxing. The dedusted flue gas is brought to the required temperature by means of heat exchangers upstream of the denoxification. The one heat exchanger is connected via a circuit for a heat transfer fluid to another heat exchanger, which is arranged downstream of the clinker cooler. Part of the air heated in the clinker cooler is discharged from the clinker cooler via a central air tapping point. This exhaust air flow is subjected to coarse dedusting in a cyclone, before the dedusted exhaust air is used to heat the heat transfer fluid in the heat exchanger on the side of the clinker cooler. The heated heat transfer fluid is fed to the heat exchanger upstream of the SCR plant. Accordingly, it is already known from the prior art to use the heat of the exhaust air for the heat displacement system of the SCR plant. The exhaust air is first dedusted and then fed to a heat exchanger, which communicates via a heat transfer fluid with a further heat exchanger upstream of the SCR plant.

A disadvantage, however, is that a cyclone is used in the exhaust air flow in this prior art in order to reduce the dust content upstream of the heat exchanger. In this embodiment, however, there is also a dust content of the exhaust air of for example several grams per standard cubic metre of air. An essential drawback of this embodiment, therefore, is that the use of the cyclone does not allow, with economically acceptable pressure losses, clean gas dust contents in the range below 100 mg/Nm³ to be achieved. The wear on the pipes and possible dust deposits (so-called fouling or scaling) therefore had to be taken into account in the process-related and structural design of the heat exchanger in the exhaust air line in order to achieve the required heat displacement capacity. The effect of these backup provisions is that the heat exchangers have to be dimensioned correspondingly larger, since otherwise the desired performance could not be transferred in the ongoing operation.

EP 2 287 126 A1 describes a cement clinker plant, wherein the off-gases are first conveyed through a cyclone and then through a high-temperature bag filter, before the off-gases are fed to a chimney. In an embodiment, a heat exchanger for cooling the off-gases to a temperature between 150° C. and 400° C. is provided downstream of the high-temperature bag filter, in order that the off-gases can be treated in a catalyst system. This prior art cannot therefore contribute towards the thermal energy of the off-gases being used for the heat displacement system of a denoxing stage.

EP 1 649 922 A1 describes a conventional cement clinker plant with a denoxing device, wherein a heat exchanger is disposed both upstream and downstream of a denoxing tower.

U.S. Pat. No. 8,765,066 B2 discloses a further generic cement clinker plant.

In contrast with this, the problem of the present invention consists in mitigating or eliminating the drawbacks of the prior art. In particular, therefore, the invention sets itself the task of using the thermal energy of kiln off-gases or clinker cooler exhaust air as efficiently as possible and with little structural outlay for the heat displacement system of the denoxing stage.

To solve this problem, an apparatus for producing cement clinker is provided with the features of claim 1. Preferred embodiments of the invention are stated in the dependent claims.

According to the invention, a hot gas filter is arranged in the direction of flow upstream of the further heat exchanger.

For the purposes of this disclosure, hot gas filters are designed for the dedusting of a dust-laden gas flow at temperatures of at least more than 260° C., preferably at temperatures of at least 450° C. Such hot gas filters are known per se in the prior art. In EP 2 545 337 B1, hot gas filters, with which approx. 450° C. hot gases can be dedusted, are however characterised as being costly and having a large volume. From this reason, the use of such hot gas filters was rejected in the prior art in favour of simpler bag filters for dedusting the off-gases. In contrast, the invention is based on the surprising finding that the arrangement of such a hot gas filter immediately upstream of the further heat exchanger brings particular advantages. An efficient and reliable dust separation at temperatures above 260° C. can thus be achieved, which enables the use of a compact, efficient heat exchanger for absorbing the off-gas heat or exhaust air heat. With the use of conventional separators, such as cyclones, the degrees of separation were usually limited at best to 50-100 mg/Nm³ (standard cubic metre), so that the downstream heat exchanger had to be adapted to such dust contents. According to the invention, on the other hand, the further heat exchanger downstream of the hot gas filter can be designed much more compact. As a result of the absence of the dust load, it is also possible to reliably prevent the heat displacement capacity being reduced as a result of dust deposits, such as fouling and scaling. An increased operational reliability of the entire heat displacement system can thus advantageously be achieved, with which the energy balance of the entire apparatus can be increased. A heat displacement from a flow of kiln off-gas and/or of exhaust air of the clinker cooler at high temperatures of more than 260° C. can thus be achieved in an efficient and economical manner. The heat exchange medium, for example water vapour or thermal oil, is fed to the heat exchanger upstream of the denoxing stage, with which heat losses of a heat exchanger module, through which off-gasses flow in a counter-flow upstream and downstream of the denoxification, are preferably compensated for. A plate heat exchanger can be provided as a heat exchanger module.

According to a preferred embodiment, a hot gas filter and a further heat exchanger are arranged in a kiln off-gas line between the preheating stage and a coarse mill for grinding the raw materials.

According to a further preferred embodiment, a hot gas filter and a further heat exchanger are arranged in a bypass line for reducing chloride loads from a partial flow of the kiln off-gases.

Cement clinker is discharged continuously from the kiln, said cement clinker usually being cooled with a clinker cooler. As a cooling agent, use can preferably be made of air, which leaves the clinker cooler as heated exhaust air.

According to a further preferred embodiment of the invention, a hot gas filter and a further heat exchanger are arranged in an exhaust air line of the clinker cooler. The further heat exchanger for absorbing heat from the exhaust air can thus advantageously be dimensioned in a compact manner.

To achieve an efficient heat displacement system, it may be necessary for at least two further heat exchangers with upstream hot gas filters to be provided in the kiln off-gas line and/or in the bypass line and/or in the exhaust air line of the clinker cooler, wherein the at least two further heat exchangers are connected to the heat exchanger upstream of the denoxing stage via sections of the line for the heat exchange medium. In this embodiment, therefore, at least two different lines comprise the further heat exchangers designed for the heat displacement to the heat exchanger upstream of the denoxing stage, wherein a hot gas filter for filtering the respective off-gas flow or exhaust air flow is in each case arranged upstream of the further heat exchangers. The thermal energy of the off-gas or exhaust air flows can be transferred at various points of the apparatus to the heat exchange medium and transported to the heat exchanger upstream of the denoxing stage. The off-gases can thus be brought reliably to the temperature required for the denoxification. The further heat exchangers with the upstream hot gas filters can be connected via separate line sections, in particular in the form of circulation lines, to the heat exchanger upstream of the denoxing stage. Alternatively, the line sections for the heating medium leading away from the further heat exchangers can be brought together in a combined section, wherein the combined section is connected to the heat exchanger upstream of the denoxing stage.

In order to make available the thermal energy required for the heat displacement to the heat exchanger upstream of the denoxing stage, it is advantageous if the kiln off-gas line and/or the bypass line and/or the exhaust air line comprises a branch line for branching off a partial flow of the kiln off-gases or the exhaust air to the further heat exchanger. In this embodiment, therefore, only a part of the off-gases or the exhaust air is branched off in the respective line, i.e. in the kiln off-gas line, the bypass line or the exhaust air line, in order to heat the heat exchange medium in the associated further heat exchanger and then to feed the heated heat exchange medium to the heat exchanger upstream of the denoxing stage.

In order to be able to adapt the thermal energy required for the heat displacement system to the current operating status, it is advantageous if the branch line is connected to a control or regulating device for adjusting the volume flow of the kiln off-gases or the exhaust air of the clinker cooler in the branch line. The control or regulating device can comprise a control unit commonly used in the prior art, with which a control or regulating valve adjusting the volume flow in the branch line is controlled.

In order to remove dust from the off-gas flow or exhaust air flow at high temperatures, it is advantageous if the hot gas filter comprises at least one filter element, preferably made of a ceramic material, through which kiln off-gases or exhaust air of the clinker cooler can flow, wherein a plurality of filter elements arranged essentially vertically are preferably provided. Such hot gas filters are generally known in the prior art, reference being made for example to DE 19 713 068 A1.

In a preferred embodiment, the hot gas filter is connected to a discharge element for discharging dust separated at the filter element. A mechanical discharge element, for example a screw conveyor, is preferably provided, which is arranged beneath the filter element.

In order to secure the function of the hot gas filter in the continuous operation, it is advantageous if the hot gas filter comprises a supply for a clean gas for cleaning the filter element. In this embodiment, it is advantageous if the hot gas filter is provided with flaps at the clean gas side, in order to clean the filter elements in the flow-free state and thus to lengthen the service lives of the ceramic filter elements.

The invention will be explained in greater detail below using preferred examples of embodiment represented in the drawing, to which however it is not intended to be limited. In detail, in the drawing:

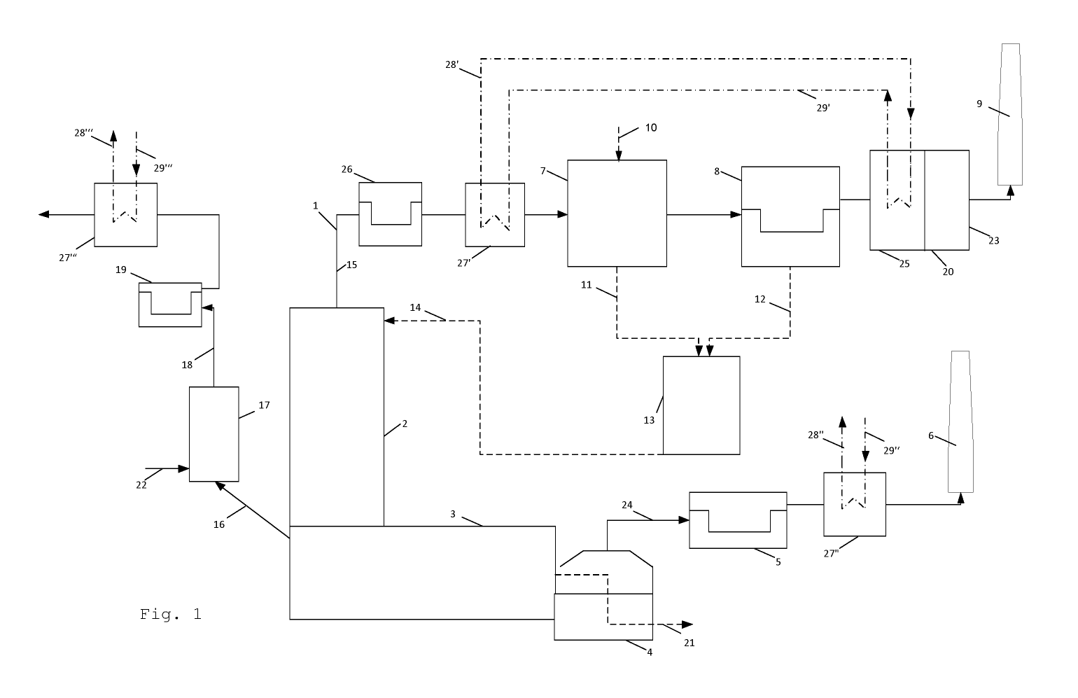

FIG. 1 shows a diagram of an apparatus according to the invention for producing cement clinker from raw meal with an SCR denoxing stage, wherein a heat displacement system is provided to compensate for heat losses of a plate heat exchanger for heating the off-gases upstream of the denoxification, which heat displacement system comprises further heat exchangers, connected to a heat exchanger upstream of the SCR denoxing stage, for utilising the heat of kiln off-gases or exhaust air of a clinker cooler, wherein a hot gas filter for filtering the kiln off-gases or the exhaust air at temperatures of more than 450° C. is disposed in each case upstream of the further heat exchangers.

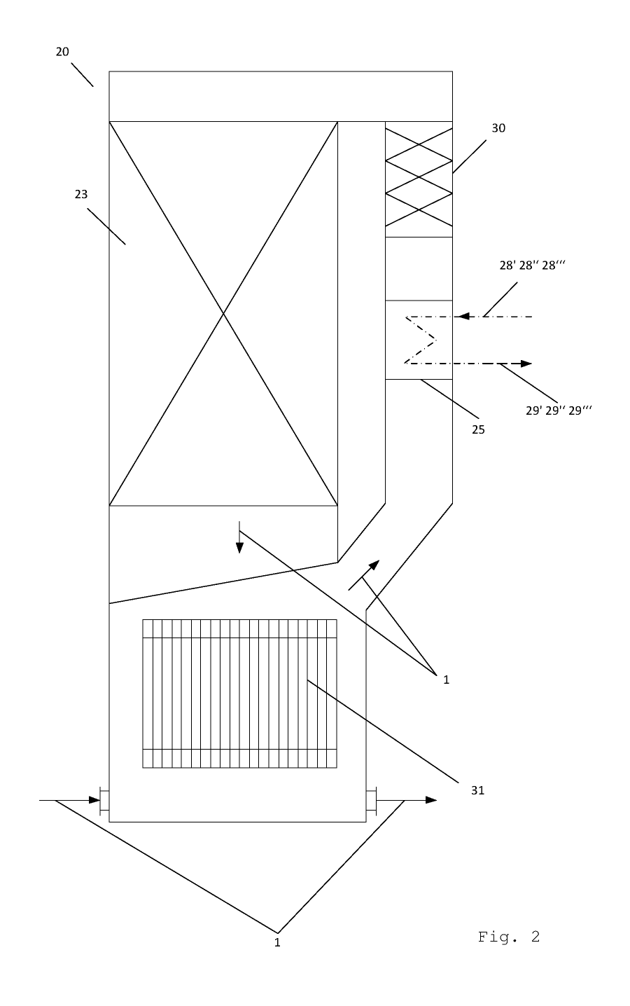

FIG. 2 shows diagrammatically the denoxing stage of the apparatus according to FIG. 1, wherein the heat losses of the plate heat exchanger are compensated for with the heat exchanger of the heat displacement system; and

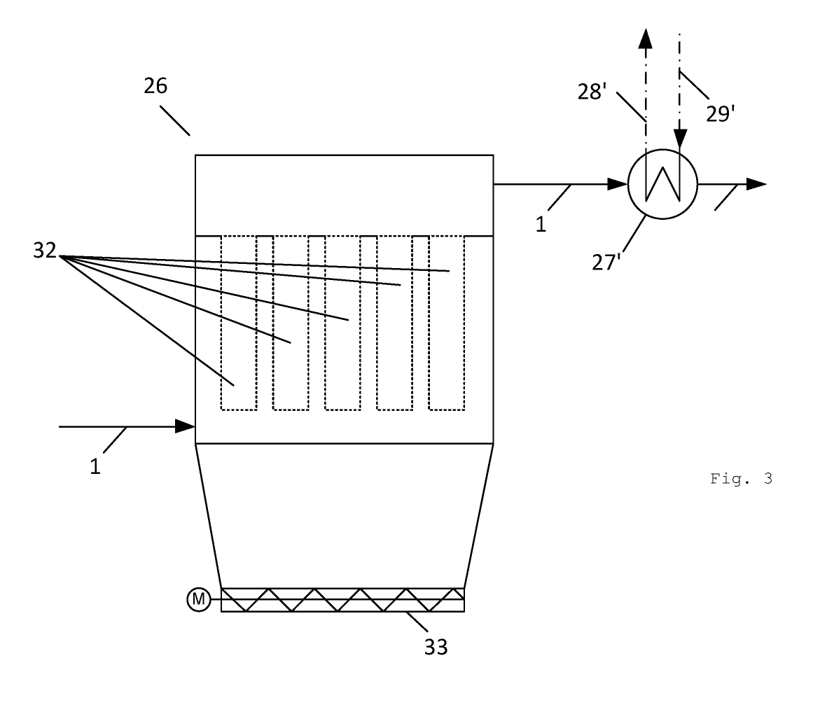

FIG. 3 shows diagrammatically an embodiment of the hot gas filter of the apparatus according to FIG. 1.

FIG. 1 shows a flow diagram of an apparatus for producing cement clinker from raw materials in the form of a raw meal, wherein the plant components known per se in the prior art are first described. The apparatus comprises in particular a (rotary) kiln 3, in which the raw materials for producing the cement clinker are calcined. Rotary kiln 3 is arranged between a clinker cooler 4 and a preheating stage 2. Preheating stage 2 comprises a plurality of cyclones (not shown), with which the raw materials are preheated. For this purpose, the raw materials are delivered via a material delivery point 14 into preheating stage 2. The raw material enters into rotary kiln 3 according to the counter-flow principle, while kiln off-gases or exhaust gases 1, arising in the calcination, flow against the flow of the raw material through preheating stage 2. The materials are separated off by the cyclones, heated up to 800° C. and transported in the direction of rotary kiln 3. Kiln off-gas 1 is simultaneously cooled from approx. 850° C. down to 300° C. to 400° C. Before the raw materials pass into rotary kiln 3, a so-called calciner (not shown in the figure) is installed in modern plants, which comprises a separate firing unit and has the task of deacifying the limestone through high temperatures and a sufficient dwell time. The raw materials are heated further in rotary kiln 3 and are finally sintered at material temperatures of up to 1600° C. to form clinker, wherein typical clinker phases (calcium-aluminium-silicates) are formed.

After preheating stage 2, off-gases 1 are conveyed via a riser 15 (“down comer duct”) into a raw mill 7, in which fresh raw material 10 is ground and dried before use in the process. Off-gases 1, which exit from preheating stage 2 at a temperature of 280 to 450° C., are used to dry the raw materials and fuels in raw mill 7. Arising raw meal 11 is fed to a homogenisation silo 13, which is connected to material delivery point 14 for preheating stage 2. After flowing through raw mill 7, the off-gases are conveyed into a filter stage 8 and dedusted. Filter stage 8 can be constituted by bag filters or electrostatic filters. Separated filter dust 12 is conveyed into homogenisation silo 13. Following filter stage 8, denitrified and dedusted off-gases 1 pass via a chimney 9 into the atmosphere.

As can further be seen from FIG. 1, clinker 21 is discharged from rotary kiln 3, said clinker being cooled in clinker cooler 4 with fresh air down to 200° C. A major part of the fresh air is used in the process as secondary and tertiary air for the calcination and a part leaves the clinker cooler as exhaust air 24 at temperatures between 200° C. and 500° C. Exhaust air 24 is finally discharged via an exhaust air chimney 6 into the atmosphere.

In modern cement works, conventional fuels such as coal dust, natural gas or heating oil are increasingly being replaced by alternative fuels. The effect of the increased use of alternative fuels is that the concentrations of alkalis or chlorides are increased in the production process. The physical properties of the chloride compounds are such that they evaporate in hot regions of the kiln and are transported with the off-gas into colder zones, where they are able to condense again on the hot meal. Chloride circulations are subsequently formed, which can lead to blockages in the pipe lines. In order to remove the chloride contents, apparatus 1 comprises a chloride bypass 16, to which a part of the flue gas exiting from rotary kiln 3 is fed at a temperature of for example approx. 1000° C. thereby bypassing preheating stage 2. The hot off-gas is cooled in a quench stage 17 with fresh air 22 to approx. 400° C. The chlorides are predominantly bound to the dust. Bypass off-gas 18 can be conveyed into a second quench stage (not shown), with which the temperature of the bypass off-gas is reduced further, in order to enable efficient dedusting in a bag filter or electrostatic filter (not shown) at temperatures below 250° C. The cleaned bypass off-gas can then be carried away via a separate bypass off-gas chimney or via chimney 9 of rotary kiln 3.

As can further be seen from FIG. 1, the apparatus also comprises a denoxing stage 20, which is constituted as an, in itself, standard SCR plant (selective catalytic reduction) for converting nitric oxides NO_{X} into harmless compounds before discharge via chimney 9. For this purpose, denoxing stage 20 comprises at least one reduction catalyst 23, in which nitric oxides NO_{X} are partially converted into nitrogen N₂ and water H₂O by a suitable catalytic reaction. In order to increase the service life of denoxing stage 20, denoxing stage 20 is arranged between filter stage 8 and chimney 9.

As can be seen from FIG. 2, a heat exchanger module 31 is arranged upstream of denoxing stage 20, with which heat exchanger module the kiln off-gases are brought, after dedusting, to the temperatures of usually 160° C. to 550° C. required for catalyst 23. In the shown embodiment, a plate heat exchanger is provided as a heat exchanger module 31, through which plate heat exchanger kiln off-gases 1 flow before their denoxification in one direction and through which kiln off-gases 1 flow after their denoxification in the other direction. The heat of outflowing kiln off-gases 1 can thus be used to preheat inflowing kiln off-gases 1. The inevitable energy losses in heat exchanger module 31 have to be compensated for by an external energy source. In the embodiment shown, a heat exchanger 25 operated with a heat exchange medium such as steam or thermal oil is provided as an energy source. Heat exchanger 25 is provided between heat exchanger module 31 and a device 30 for jetting-in and distributing a reducing agent.

Such apparatuses for producing cement clinker are generally known in the prior art, wherein the apparatus in the embodiment shown comprises additional plant components, which are to be explained below.

As can be seen from FIG. 1, the apparatus comprises further heat exchangers 27′, 27″, 27′″, with which the heat from flows of off-gas 1 or exhaust air 24 of clinker cooler 4 is used for heating a heat exchange medium, which is fed to heat exchanger 25 to compensate for the heat losses of heat exchanger module 31. Further heat exchangers 27′, 27″, 27′″ are connected to heat exchanger 25 upstream of denoxing stage 20 via lines 28′, 29′; 28″, 29″; 28′″, 29′″ transporting the heat exchange medium. Lines 28′, 29′; 28″, 29″; 28′″, 29′″ are constituted as circulation lines, which each comprise a supply line 28′; 28″; 28′″ transporting the heated heat exchange medium from further heat exchanger 27′, 27″, 27′″ to heat exchanger 25 and a discharge line 29′; 29″; 29′″ conveying the cooled heat exchange medium from heat exchanger 25 to further heat exchanger 27′, 27″, 27′″.

As can be seen from FIG. 1, the apparatus in the shown embodiment in each case comprises a hot gas filter 26, 5, 19 in the flow direction of the gas flow concerned, i.e. the off-gas or the exhaust air of clinker cooler 4, immediately upstream of further heat exchanger 27′, 27″, 27′″. For the purposes of this disclosure, the “immediate” arrangement of hot gas filter 26, 5, 19 upstream of further heat exchanger 27′, 27″, 27′″ is intended in particular to mean that the kiln off-gas flow or exhaust air flow concerned, after dedusting in hot gas filter 26, 5, 19, is conveyed, without flowing through any other plant components, into further heat exchanger 27′, 27″, 27′″, in order to deliver a part of the heat stored in kiln off-gases 1 or in the exhaust air of clinker cooler 4 to the heat exchange medium.

As can be seen from FIG. 1, a hot gas filter 26 is arranged upstream of further heat exchanger 27′ in the kiln off-gas line between preheating stage 2 and a raw mill 7 for grinding the raw materials.

As can be seen from FIG. 1, a hot gas filter 19 is also disposed upstream of a further heat exchanger 27′″ in bypass line 16 for the removal of chloride contents from a partial flow of the kiln off-gases.

As can be seen from FIG. 1, a further hot gas filter 5 is finally arranged upstream of a further heat exchanger 27″ in the exhaust air line of clinker cooler 4.

Lines 28″, 29″ of further heat exchanger 27″ in the exhaust air line of clinker cooler 4 and lines 28′″, 29′″ of further heat exchanger 27′″ in bypass line 16 can be brought together in combined sections with lines 28′, 29′ of further heat exchanger 27′ in the kiln off-gas line (not shown). Moreover, the kiln off-gas line and/or the bypass line and/or the exhaust air line can comprise a branch line (not shown), with which only a partial flow of the respective flow of kiln off-gases or exhaust air can be branched off to further heat exchanger 27′, 27″, 27′″. In this embodiment, the branch line can be connected to a control or regulating device (not shown) for adjusting the volume flow of the kiln off-gases or the exhaust air of the clinker cooler in the branch line.

As can be seen from FIG. 3, hot gas filter 26 (the other hot gas filters 5, 19 are designed correspondingly) comprises a plurality of filter elements 32, through which the respective gas flow, here kiln off-gases 1, flow in order to separate the dust contents. Ceramic filter elements are provided in the shown embodiment. It can also be seen in FIG. 3 that hot gas filter 26 is connected to a mechanical discharge element 33 for discharging the dust separated at filter elements 32. Moreover, hot gas filter 26, 5, 19 can comprise a supply for a clean gas for cleaning filter elements 32 (not shown).

1. An apparatus for producing cement clinker, comprising a kiln for calcining raw materials to form cement clinker, comprising a preheating stage for preheating the raw materials in a counter-flow to kiln off-gases, comprising a clinker cooler for cooling the cement clinker, comprising a denoxing stage for denoxing kiln off-gases, comprising a heat exchanger for heating the kiln off-gases upstream of the denoxing stage by heat exchange with a heat exchange medium, comprising at least one further heat exchanger for heating the heat exchange medium by heat exchange with kiln off-gases or exhaust air of the clinker cooler, wherein the heat exchanger is connected to the further heat exchanger via a line for the heat exchange medium, wherein a hot gas filter is arranged in the flow direction upstream of the further heat exchanger.

2. The apparatus according to claim 1, wherein a hot gas filter and a further heat exchanger are arranged in a kiln off-gas line between the preheating stage and a raw mill for grinding the raw materials.

3. The apparatus according to claim 1, wherein a hot gas filter and a further heat exchanger are arranged in a bypass line for reducing chloride loads from a partial flow of the kiln off-gases.

4. The apparatus according to claim 1, wherein a hot gas filter and a further heat exchanger are arranged in an exhaust air line of the clinker cooler.

5. The apparatus according to claim 1, wherein at least two further heat exchangers with upstream hot gas filters are provided in the kiln off-gas line and/or in the bypass line and/or in the exhaust air line of the clinker cooler, wherein the at least two further heat exchangers are connected to the heat exchanger upstream of the denoxing stage via sections of the line for the heat exchange medium.

6. The apparatus according to claim 1, wherein the kiln off-gas line and/or the bypass line and/or the exhaust air line comprises a branch line for branching off a partial flow of the kiln off-gases or the exhaust air to the further heat exchanger.

7. The apparatus according to claim 6, wherein the branch line is connected to a control or regulating device for adjusting the volume flow of the kiln off-gases or the exhaust air of the clinker cooler in the branch line.

8. The apparatus according to claim 1, wherein the hot gas filter comprises at least one filter element, through which kiln off-gases or exhaust air of the clinker cooler flow.

9. The apparatus according to claim 8, wherein the hot gas filter is connected to a discharge element for discharging dust separated at the filter element.

10. The apparatus according to claim 8, wherein the hot gas filter comprises a supply for a clean gas for cleaning the filter element.

11. The apparatus according to claim 8, wherein the at least one filter element is made of a ceramic material.

12. The apparatus according to claim 8, wherein a plurality of ceramic filter elements arranged essentially vertically are provided.

13. The apparatus according to claim 5, wherein the kiln off-gas line and/or the bypass line and/or the exhaust air line comprises a branch line for branching off a partial flow of the kiln off-gases or the exhaust air to the at least two further heat exchangers.

14. The apparatus according to claim 7, wherein the hot gas filter comprises at least one filter element through which kiln off-gases or exhaust air of the clinker cooler flow.

15. The apparatus according to claim 14, wherein the at least one filter element is made of a ceramic material.

16. The apparatus according to claim 14, wherein a plurality of ceramic filter elements arranged essentially vertically are provided.
